(19) United States
(12) Patent Application Publication
(10) Pub. No.: US 2009/0171896 A1
(43) Pub. Date: Jul. 2, 2009

(54) METHOD AND SYSTEM FOR GENERATING A LINK HIERARCHY

(76) Inventors: HERBERT HACKMANN, Wiesloch (DE); Ulrich Spinola, Weinheim (DE)

Correspondence Address: SAP AG, 3410 HILLVIEW AVENUE, PALO ALTO, CA, 94304, US

(21) Appl. No.: 11/965,801

(22) Filed: Dec. 28, 2007

(51) Int. Cl. G06F 17/30; G06F 7/10

(52) U.S. Cl. 707/3; 707/102; 707/E17.009; 707/E17.014

(57) ABSTRACT

A method and system for generating a link hierarchy is provided. A configuration data is generated. A link hierarchy is generated using the configuration data. A first node is generated in the link hierarchy of instance type. A second node is generated in the link hierarchy of query type. A third node is generated in the link hierarchy of target placeholder type that is instantiable by create. A fourth node is generated in the link hierarchy of target placeholder type instantiable by query. A data object assembly is generated using the link hierarchy.

### TECHNICAL FIELD

Embodiments of the invention generally relate to computer systems, and more particularly to a method and system for generating a link hierarchy.

### BACKGROUND

In the business software world, most of the business software is typically developed in a model driven way. The process of developing software in a model driven way generally involves identifying fine-granular and standardized data models and mapping a set of data objects to the data model to generate a data object assembly. The data object assemblies typically define a well defined business processes. The data object assembly is typically generated at modeling time or design time and a user is not allowed to make any changes to the data object assembly. Currently there is no software development method available that provides a flexible programming model to allow the user to develop a required data object assembly both during configuration time or runtime. These software development methods do not provide any ready to use components that may be configured during configuration time or runtime to generate the data object assembly of choice for use in an application.

### SUMMARY OF THE INVENTION

Embodiments of the invention are generally directed to a method and system for generating a link hierarchy. A configuration data is generated. A link hierarchy is generated using the configuration data. A first node is generated in the link hierarchy of instance type. A second node is generated in the link hierarchy of query type. A third node is generated in the link hierarchy of target placeholder type that is instantiable by create. A fourth node is generated in the link hierarchy of target placeholder type instantiable by query. A data object assembly is generated using the link hierarchy.

These and other benefits and features of embodiments of the invention will be apparent upon consideration of the following detailed description of preferred embodiments thereof, presented in connection with the following drawings in which like reference numerals are used to identify like elements throughout.

### BRIEF DESCRIPTION OF THE DRAWINGS

The claims set forth the embodiments of the invention with particularity. The embodiments of the invention, together with its advantages, may be best understood from the following detailed description taken in conjunction with the accompanying drawings. The invention is illustrated by way of example and not by way of limitation in the figures of the accompanying drawings. It should be noted that references to “an” or “one” embodiment in this disclosure are not necessarily to the same embodiment, and such references mean at least one.

FIG. 1 is a functional block diagram of a system for generating a link hierarchy according to an embodiment of the invention.

FIG. 2 is a functional block diagram of a system for implementing a link hierarchy according to an embodiment of the invention.

FIG. 3 is a flow diagram of a process for generating a link hierarchy according to an embodiment of the invention.

FIG. 4A is a first part of a flow diagram of a process for generating a link hierarchy according to an embodiment of the invention.

FIG. 4B is a second part of the flow diagram in FIG. 4A of a process for generating a link hierarchy according to an embodiment of the invention.

FIG. 5 is a block diagram of a system for generating a link hierarchy useful for implementing the invention according to an embodiment of the invention.

### DETAILED DESCRIPTION

Embodiments of the invention are generally directed to a method and system for generating a link hierarchy. A configuration data is generated. A link hierarchy is generated using the configuration data. A first node is generated in the link hierarchy of instance type. A second node is generated in the link hierarchy of query type. A third node is generated in the link hierarchy of target placeholder type that is instantiable by create. A fourth node is generated in the link hierarchy of target placeholder type instantiable by query. A data object assembly is generated using the link hierarchy.

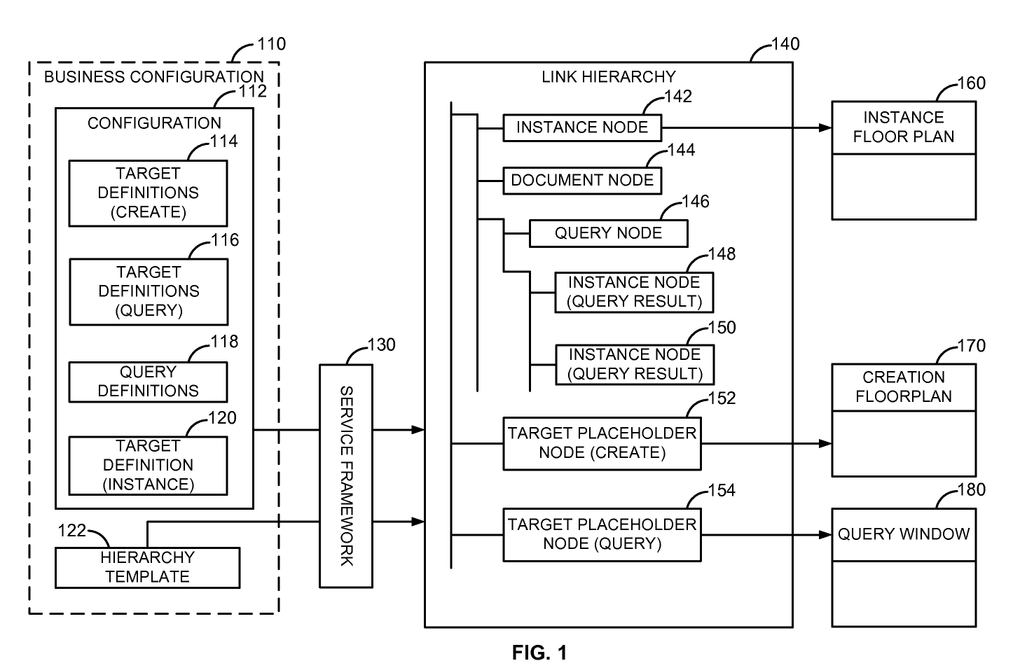

FIG. 1 is a functional block diagram of a system for generating a link hierarchy according to an embodiment of the invention. Link hierarchy 140 typically includes one or more folder nodes arranged in a hierarchical order. A folder node in link hierarchy 140 may point to (or linked to) one or more data object instances, documents or a query. In an embodiment a folder node in link hierarchy 140 may include business properties. Link hierarchy 140 may include folder nodes of instance type, query type, target placeholder type that are instantiable by create and target placeholder type that are instantiable by query.

Instance node 142 in link hierarchy 140 is a folder node of instance type. Instance node 142 is typically used to link data object instances when configuration 112 is generated for instance node 142 in business configuration 110 during a configuration time. Generating configuration 112 for instance node 142 includes generating target definition 120. Target definition 120 typically includes definitions of one or more data objects associable with the link hierarchy. Target definition 120 may also include definitions of one or more data object instances associable to the link hierarchy for each of the data objects. In an embodiment target definition 120 may include one or more definitions of data objects and data object instances associable with instance node 142. The definitions of data objects may include a data object name, a data object identifier, a short text for the data object and a customizing attribute. The short text is usually visible to a user as the name of the data object while working with link hierarchy 140 in a user interface. The definitions of data object instances may include a data object instance name, a data object instance key and a short text. The user may view the data objects and the corresponding data object instances for each data object that have configuration 112 generated in business configuration 110 in the user interface. The user may select a data object and one or more data object instances for linking with instance node 142. In an embodiment a data object may be linked to instance node 142 as a parent node and one or more data object instances may be linked to instance node 142 as child nodes of the data object. In an embodiment if configuration 112 is not generated for instance node 142 during the configuration time, the user may configure the data objects and the data object instances during the runtime using the user interface. In an embodiment, instance node 142 has a persistent character as a data object instance identifier of the data object instance linked to instance node 142 is stored in link hierarchy 140.

Query node 146 in link hierarchy 140 is a folder node of query type. Query node 146 may be used to execute a query in a data object. The instance nodes 148 and 150 are data object instances obtained as a result (query result) of executing the query. The query, the data object and one or more query parameters based on which the query is executed in the data object is defined as query definitions 118 in configuration 112. In an embodiment, instance nodes 148 and 150 have a transient character with the data object instances being determined at runtime and the data object instance identifiers of the data object instances not being stored in link hierarchy 140. Query definition 118 for query node 146 typically includes a query name, one or more query parameters and a data object name of the data object. In an embodiment query definition 118 may be configured during the configuration time or the runtime.

Target placeholder node 152 in link hierarchy is a folder node of target placeholder type that is instantiable by create. Target placeholder node 152 is typically used to create new data object instances using creation floorplan 170 of a data object and link the data object instances to link hierarchy. A data object for target placeholder node 152 is typically configured in target definition 114 in configuration 112. Target definition 114 for target placeholder node 152 generally includes a data object name of the data object a system identifier and a client. In an embodiment, target placeholder node 152 may be configured as a wildcard node in configuration 112 to enable the user to configure target placeholder node 152 during the runtime.

Target placeholder node 154 in link hierarchy 140 is a folder node of target placeholder type that is instantiable by query. Target placeholder node 154 is typically used to execute a query in a data object, obtain one or more data object instances as a result of executing the query, selecting and linking one or more data object instances to link hierarchy 140. The query is typically executed in the data object in query window 180. The query, the data object and one or more query parameters based on which the query is executed in the data object is defined as target definition 116 in configuration 112. Target definition 116 for target placeholder node 154 typically includes a query name of the query, one or more query parameters and a data object name of the data object. In an embodiment, target placeholder node 154 may be configured as a wildcard node in configuration 112 to enable the user to configure target placeholder node 154 during the runtime.

In an embodiment target placeholder nodes 152 and 154 may be configured for the replaceable by a link during the configuration time or the time.

Document node 144 in link hierarchy 140 is a folder node that is typically used to incorporate one or more documents in link hierarchy 140. In an embodiment, one or more documents may be stored as an attachment to document node 144. In an embodiment, one or more document data object instances may be linked to document node 144.

Hierarchy template 122 may be defined as part of business configuration 110. Hierarchy template 122 typically defines the hierarchical order of the folder nodes in link hierarchy 140. A node assignment is generally done in hierarchy template during the configuration time. The node assignment usually includes assigning node identifiers of nodes in link hierarchy 140 to folder nodes to define the type of the node. The type of the node may include instance type, query type or target placeholder type.

In an embodiment instance nodes 142, 148 and 150 may be used to view instance floorplan 160 of the data objects corresponding to the instance nodes.

In an embodiment link hierarchy 140 receives configuration 112 and hierarchy template 122 from business configuration 110 stored in a backend through service framework 130 such as an Enterprise Service Framework (ESF). In an embodiment service framework 130 handles one or more activity requests made on link hierarchy 140. The activity requests may include requests to create a node, display a node, query a node, search the entire link hierarchy 140, link a data object instance to a node and the like.

In an embodiment link hierarchy 140 may be used to generate a data object assembly for a required business purpose. An example of a data object assembly generated by using link hierarchy 140 is a hierarchical directory structure having one or more folders and one or more subfolder for each folder. A folder or subfolder in the hierarchical directory structure may further include one or more files. The folder and subfolders may be the folder nodes in link hierarchy 140. The files in a folder or a subfolder may be data object instances linked to link hierarchy 140.

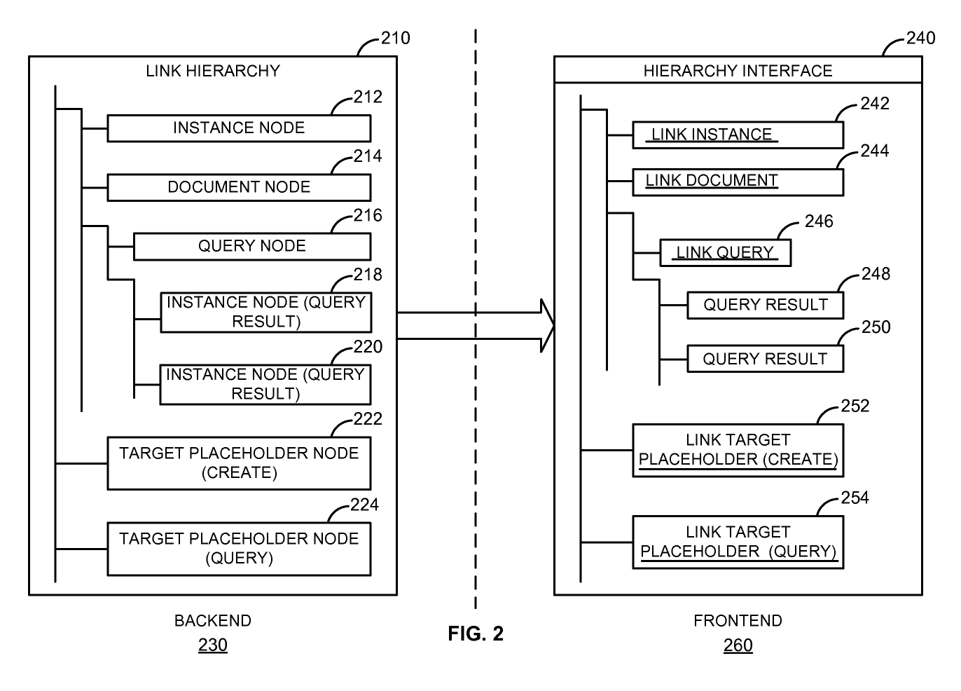

FIG. 2 is a functional block diagram of a system for implementing a link hierarchy according to an embodiment of the invention. Link hierarchy 210 is typically stored in backend 230. Link hierarchy 210 is presented in frontend 260 as hierarchy interface 240. Hierarchy interface 240 typically provides an interface for a user to generate a data object assembly using link hierarchy 210 to suit a business process. Hierarchy interface 240 generally includes interface elements link instance 242, link document 244, link query 246, link target placeholder 252 and link target placeholder 254 mapped to the corresponding folder nodes in link hierarchy 210. In an embodiment hierarchy interface 240 has exactly one interface element for each node in link hierarchy 210. Link instance 242 is mapped to instance node 212 and may be used to link data object instances to instance node 212. In an embodiment, the user on selecting link instance 242 is provided with a list of data objects and a corresponding data object instances for each data object that have a configuration generated in a business configuration. The user may select a data object and one or more data object instances for linking with instance node 212. Link document 244 is mapped to document node 214 and may be used to incorporate one or more documents in link hierarchy 210 as an attachment or as data object instances. Link query 246 is mapped to query node 216 and may be used to execute a query in a data object configured in the business configuration stored in backend 230. Query results 248 and 250 are mapped to instance nodes 218 and 220 and may be used to display data object instances obtained as a result of executing the query in the query window. Link target placeholder 252 is mapped to target placeholder node 222 and may be used to create and link data object instances to target placeholder node 222. In an embodiment, the user is provided with an instance floorplan window of a business object on selecting link target placeholder 252 for creating new data object instances. Link target placeholder 254 is mapped to target placeholder node 224 and may be used to link data object instances instantiable by query to target placeholder node 224. The user is typically presented with a query window on selecting link query 246 for executing a query on the data object. The user may then view and select one or more data object instances obtained as a result of executing the query in the query window for linking with target placeholder node 224.

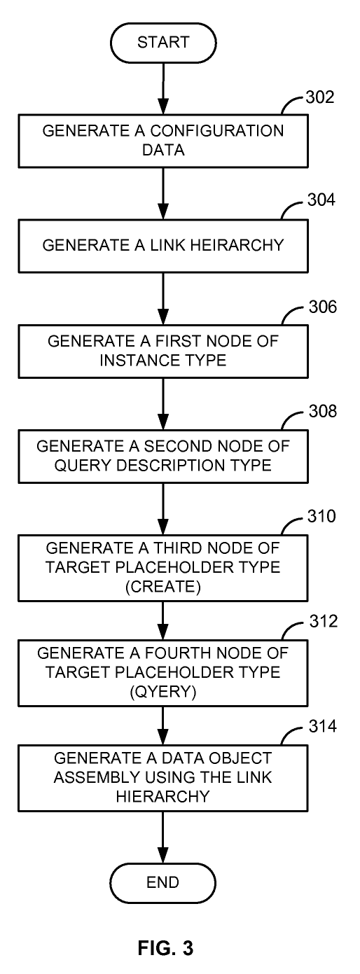

FIG. 3 is a flow diagram of a process for generating a link hierarchy according to an embodiment of the invention. In process block 302, a configuration data is generated typically in a business configuration stored in a backend. In process block 304, a link hierarchy is generated using the configuration data. The link hierarchy typically includes one or more folder nodes arranged in a hierarchical order. A folder node in the link hierarchy may point to (or linked to) one or more data object instances, documents or a query. The configuration data typically includes a hierarchy template that defines the hierarchical order of the folder nodes in the link hierarchy. In process block 306, a first node of instance type is generated in the link hierarchy. The first node is typically a folder node and may be used to link one or more data object instances to the first node. In process block 308, a second node of query type is generated in the link hierarchy. The second node is typically a folder node and may be used for executing a query in a data object configured as the configuration data. One or more data object instances obtained as a result of executing the query are typically linked to the second node. In process block 310, a third node of target placeholder type that is instantiable by create is generated in the link hierarchy. The third node is typically a folder node and may be used to create and link new data object instances to the third node. In process block 312, a fourth node of target placeholder type that is instantiable by query is generated in the link hierarchy. The fourth node is typically a folder node and may be used for linking one or more data object instances to the fourth node by querying a data object. The query and the data object are configured as part of the configuration data. The query is executed in the data object and one or more data object instances obtained as a result of executing the query may be selected for linking to the fourth node. In process block 314, a data object assembly is generated using the link hierarchy.

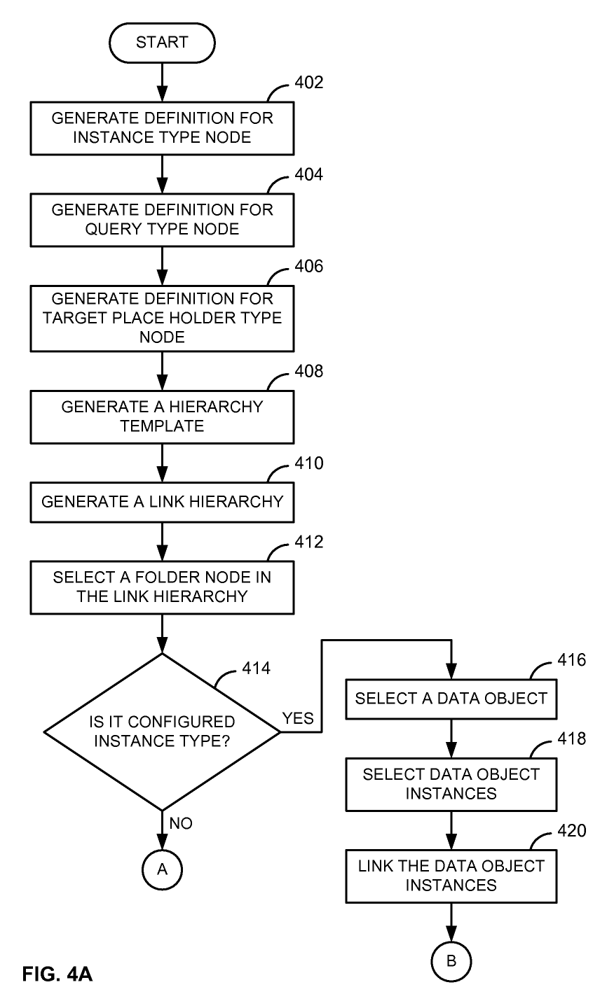

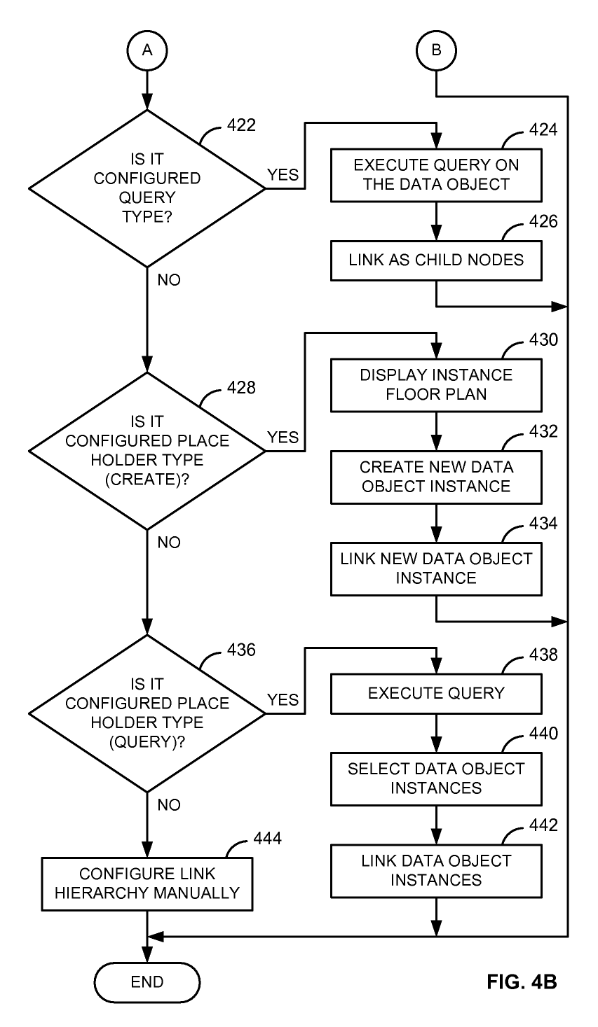

FIG. 4A is a first part of a flow diagram of a process for generating a link hierarchy according to an embodiment of the invention. In process block 402, a definition for an instance type node is generated. The definition for the instance type node typically includes definitions of one or more data objects associable with a link hierarchy and definitions of one or more data object instances associable to the link hierarchy for each of the data objects. The definitions of the data objects may include a data object name, a data object identifier, a short text for the data object and a customizing attribute. The definitions of the data object instances may include a data object instance name, a data object instance key and a short text. In process block 404, a definition for a query type node is generated. The definition of a query type node typically includes the definitions of a query and the data object on which the query may be executed for conducting a search in the data object. The definition of the query type node a query name, one or more query parameters and a data object name of the data object. In process block 406, a definition of a target placeholder type node is generated. The target placeholder node may either be instantiable by create or instantiable by query. The definition of a target placeholder type node that is instantiable by create typically includes a data object name of a data object, a system identifier and a client. The definition of a target placeholder type node that is instantiable by query typically includes a query name, one or more query parameters and a data object name. In process block 408, a hierarchy template is generated. In an embodiment, the definitions of the instance type node, the query type node, the target placeholder type node and the hierarchy template are generated and stored in a business configuration.

In process block 410 a link hierarchy is generated from the definitions of the instance type node, the query type node, the target placeholder type node and the hierarchy template are stored in the business configuration. The link hierarchy typically includes one or more folder nodes arranged in a hierarchical order. A folder node in the link hierarchy may point to (or linked to) one or more data object instances, documents or a query. A folder node is typically generated for each definition of a node type in the link hierarchy. Thus, one or more folder nodes are generated of instance type, query type, target placeholder type that is instantiable by create and target placeholder type that is instantiable by query. The folder node of instance type may be used to link one or more data object instances to the link hierarchy. The folder node of query type may be used for executing a query in a data object configured as the configuration data. One or more data object instances obtained as a result of executing the query are typically linked to the folder node of query type. The folder node of target placeholder type that is instantiable by create may be used to create and link new data object instances to the link hierarchy. The folder node of target placeholder type that is instantiable by query may be used for linking one or more data object instances to the link hierarchy by querying a data object. The query is executed in the data object and one or more data object instances obtained as a result of executing the query may be selected for linking to the link hierarchy.

In process block, 412 a folder node is selected in the link hierarchy interface typically by a user using a hierarchy interface. In decision block 414, if the folder node is of a configured instance type, the process moves to process block 416. In process block 416 the user selects a data object from a list of data objects configured for the instance type node. In process block 418, the user selects one or more data object instances from a list of data object instances configured for the data object. In process block 420, the data object instances are linked to the folder node of the configured instance type. In decision block 414, if the folder node is not of the configured instance type, the process moves to decision block 422 in FIG. 4B.

FIG. 4B is a second part of the flow diagram in FIG. 4A of a process for generating a link hierarchy according to an embodiment of the invention. In decision block 422, if the folder node is of a configured query type, the process moves to process block 424. In process block 424, the query configured the query type node is executed in the data object configured for the query type node. In process block 426, one or more data object instances obtained as a result of executing the query are linked to the folder node of the configured query type.

In decision block 422, if the folder node is not of the configured query type, the process moves to decision block 428. In decision block 428 if the folder node is of a configured placeholder type that is instantiable by create, the process moves to process block 430. In process block 430, an instance floorplan of the data object configured for the target placeholder type node is displayed to the user in the hierarchy interface. In process block 432, the user creates a new data object instance using the instance floorplan. In process block 434, the new data object instance is linked to the folder node of the configured target placeholder type that is instantiable by create.

In decision block 422, if the folder node is not of the configured placeholder type, the process moves to decision block 436. In decision block 436, if the folder node is of a configured target placeholder type that is instantiable by query, the process moves to process block 438. In process block 438, the query configured for target placeholder type node is executed in the data object configured for the target placeholder type node. In process block 440, one or more data object instances are selected from a list of data object instances obtained as a result of executing the query. In process block 442, the data object instances are linked to the folder node of the configured target placeholder type that is instantiable by query.

In decision block 436 if the folder node is not of the configured target placeholder type, the process moves to process block 444 where the link hierarchy is manually configured by the user during runtime using the hierarchy interface.

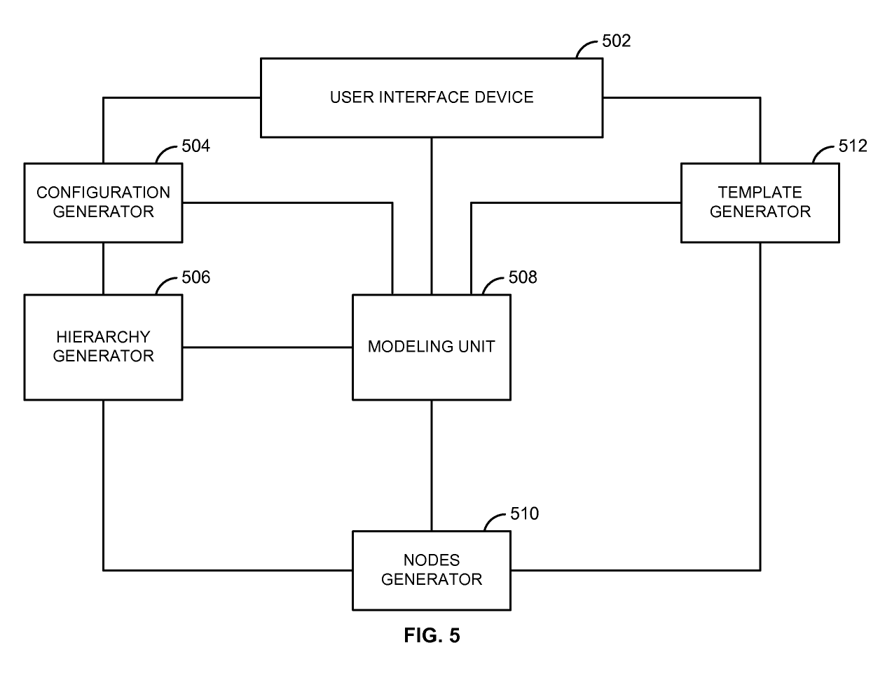

FIG. 5 is a block diagram of a system for generating a link hierarchy useful for implementing the invention according to an embodiment of the invention. Hierarchy generator 506 is responsible for generating a link hierarchy based on a configuration generated by configuration generator 504. The link hierarchy typically includes one or more folder nodes arranged in a hierarchical order. A folder node in the link hierarchy may point to (or linked to) one or more data object instances, documents or a query. The link hierarchy may include the folder nodes of instance type, query type, target placeholder type that are instantiable by create and target placeholder type that are instantiable by query. The configuration generated by configuration generator 504 typically includes a target definition for the folder node of instance type, a query definition for the folder node of query type, a target definition for the folder node of target placeholder type that is instantiable by create and a target definition for the folder node or target placeholder type that is instantiable by query. In an embodiment a user may use user interface 502 for generating the configuration data using configuration generator 504. Node generator 510 typically generates one or more folder nodes in the link hierarchy of instance type, query type, target placeholder type that is instantiable by create and target placeholder type that is instantiable by query using the configuration data. Template generator 512 is typically responsible for generating a structure template. The structure template typically defines a hierarchical order of nodes in the link hierarchy. In an embodiment, the user through user interface 502 may generate a structure template using template generator. Modeling unit 508 enables the user to work with the link hierarchy. Using modeling unit 508 the user may link data object instances to the nodes in the link hierarchy for generating a data object assembly.

The particular methods associated with embodiments of the invention are described in terms of computer software and hardware with reference to flowcharts. The methods to be performed by a computing device (e.g., an application server) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

Elements of the invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

What is claimed is:

1. A method comprising:
generating a configuration data;
generating a link hierarchy using the configuration data;
generating a first node in the link hierarchy of instance type;
generating a second node in the link hierarchy of query type;
generating a third node in the link hierarchy of target placeholder type that is instantiable by create;
generating a fourth node in the link hierarchy of target placeholder type that is instantiable by query; and
generating a data object assembly using the link hierarchy.

2. The method of claim 1, wherein generating a configuration data comprises:
generating a first definition for the second node having a data object name, a query name and a query parameter;
generating a second definition for the third node having a data object name, a system identifier and a client; and
generating a third definition for the fourth node having a data object name, a query name and a query parameter.

3. The method of claim 1, wherein generating a configuration data comprises:
generating a first definition of a data object associable with the link hierarchy; and
generating a second definition of a data object instance associable with the link hierarchy.

4. The method of claim 1, wherein generating a configuration data comprises generating a structure template for the link hierarchy.

5. The method of claim 1 further comprising:
selecting a data object instance from a list of data object instances; and
generating a link from a node in the link hierarchy to the instance of the data object.

6. The method of claim 1 further comprising:
selecting a data object type from a list of data object types; and
selecting a data object instance from a list of data object instances for the data object type.

7. The method of claim 1 further comprising storing an instance identifier of a data object instance in the link hierarchy.

8. The method of claim 1 further comprising:
initiating a query using the second node for executing a search in a data object;
selecting a data object instance obtained as a result of the search; and
generating a transient link from the second node to a data object instance obtained as a result of the search.

9. The method of claim 1 further comprising storing a grouping attribute in the link hierarchy for grouping two or more data object instances.

10. A system comprising:
a configuration generator for generating a configuration data;
a hierarchy generator electronically coupled to the configuration generator for generating a link hierarchy using the configuration data;
a node generator electronically coupled to the hierarchy generator for generating a first node in the link hierarchy of instance type, a second node in the link hierarchy of query type, a third node in the link hierarchy of target placeholder type that is instantiable by create and a fourth node in the link hierarchy of target placeholder type that is instantiable by query; and
a modeling unit electronically coupled to the configuration generator, the hierarchy generator and the node generator for generating a data object assembly using the link hierarchy.

11. The system of claim 10 further comprising a template generator electronically coupled to the node generator and the modeling unit for generating a structure template for the link hierarchy.

12. A machine-accessible medium that provides instructions that, when executed by a machine, cause the machine to perform operations comprising:
generating a configuration data;
generating a link hierarchy using the configuration data;
generating a first node in the link hierarchy of instance type;
generating a second node in the link hierarchy of query type;
generating a third node in the link hierarchy of target placeholder type that is instantiable by create;
generating a fourth node in the link hierarchy of target placeholder type that is instantiable by query; and
generating a data object assembly using the link hierarchy.

13. The machine-accessible medium of claim 12, wherein generating a configuration data comprises:
generating a first definition for the second node having a data object name, a query name and a query parameter;
generating a second definition for the third node having a data object name, a system identifier and a client; and
generating a third definition for the fourth node having a data object name, a query name and a query parameter.

14. The machine-accessible medium of claim 12, wherein generating a configuration data comprises:
generating a first definition of a data object associable with the link hierarchy; and
generating a second definition of a data object instance associable with the link hierarchy.

15. The machine-accessible medium of claim 12, wherein generating a configuration data comprises generating a structure template for the link hierarchy.

16. The machine-accessible medium of claim 12 further providing instructions which when executed by the machine cause the machine to perform further operations comprising:
selecting a data object instance from a list of data object instances; and
generating a link from a node in the link hierarchy to the instance of the data object.

17. The machine-accessible medium of claim 12 further providing instructions which when executed by the machine cause the machine to perform further operations comprising:
selecting a data object type from a list of data object types; and
selecting a data object instance from a list of data object instances for the data object type.

18. The machine-accessible medium of claim 12 further providing instructions which when executed by the machine cause the machine to perform further operations comprising storing an instance identifier of a data object instance in the link hierarchy.

19. The machine-accessible medium of claim 12 further providing instructions which when executed by the machine cause the machine to perform further operations comprising:
initiating a query using the second node for executing a search in a data object;
selecting a data object instance obtained as a result of the search; and
generating a transient link from the second node to a data object instance obtained as a result of the search.

20. The machine-accessible medium of claim 12 further providing instructions which when executed by the machine cause the machine to perform further operations comprising storing a grouping attribute in the link hierarchy for grouping two or more data object instances.
